(19) United States
(12) Patent Application Publication
(10) Pub. No.: US 2025/0191316 A1
(43) Pub. Date: Jun. 12, 2025

(54) AR IMAGE RECEIVING DEVICE AND METHOD

(71) Applicant: KOREA ELECTRONICS TECHNOLOGY INSTITUTE, Seongnam-si (KR)

(72) Inventors: Woo Chool PARK, Incheon (KR); Jun-Hwan JANG, Goyang-si (KR); Jin Wook YANG, Uijeongbu-si (KR); Minsu CHOI, Seoul (KR); Junsuk LEE, Seoul (KR); Bonjae KOO, Suwon-si (KR)

(21) Appl. No.: 19/060,082

(22) Filed: Feb. 21, 2025

Related U.S. Application Data
(63) Continuation of application No. PCT/KR2022/019642, filed on Dec. 5, 2022.

(30) Foreign Application Priority Data
Aug. 22, 2022 (KR) 10-2022-0104797

(51) Int. Cl. G06T 19/00; G06T 5/20; G06T 5/70; G06T 9/00; G06V 10/25; H04N 21/434; H04N 21/8547

(52) U.S. Cl. CPC G06T 19/006; G06T 5/20; G06T 5/70; G06T 9/00; G06V 10/25; H04N 21/434; H04N 21/8547

(57) ABSTRACT

An augmented reality (AR) image receiving device and method is proposed. Decoding rendering may be carried out with a color masking image, and a video masking image of a specific object, which have been received in real-time via a communication network, and then binding may be carried out with a camera image, and thus the boundary of the specific object may be clearly distinguished, thereby enabling the enhancement of resolution and immersion.

### CROSS REFERENCE TO RELATED APPLICATIONS

This is a continuation application of International Patent Application No. PCT/KR2022/019642, filed on Dec. 5, 2022, which claims priority to Korean patent application No. KR 10-2022-0104797 filed on Aug. 22, 2022, contents of each of which are incorporated herein by reference in their entireties.

### BACKGROUND

### Technical Field

The present disclosure relates to an augmented reality (AR) image receiving device and method, and more particularly, to a technology for providing a high image quality AR service by processing color masking images and video masking images and camera images received in real time.

### Description of Related Technology

Recently, the demand for augmented reality devices or mixed reality devices that provide various information by overlaying virtual images on images or backgrounds of the real world has been rapidly increasing.

### SUMMARY

One aspect is to improve resolution and immersion by synchronizing a color masking image of a specific object and a video masking image of the specific object through a communication network and then binding them with a camera image, thereby clearly distinguishing the boundary of the specific object.

The aspects of the present disclosure are not limited to the aspects disclosed herein, and other aspects and advantages of the present disclosure that are not mentioned may be understood by the following description and will be more clearly understood by the embodiment of the present disclosure. In addition, it will be easily understood that the aspects and advantages of the present disclosure can be realized by the means and combinations thereof indicated in the claims.

Another aspect is an AR image receiving device that includes: a receiving unit configured to receive content, and by using session information of each of a color masking image and a video masking image for an object in a region of interest within the received content, to demultiplex the color masking image and the video masking image, respectively; a synchronization unit configured to synchronize the video masking image and the color masking image by using timestamps of the demultiplexed color masking image and video masking image; a decoding unit configured to decode the synchronized video masking image and color masking image, respectively; and a processor configured to transform the decoded video masking image and color masking image at the pixel level, respectively, and then extract pixel images in a region where the transformed video masking image and color masking image match, and then bind the extracted pixel images and pixel-level camera images acquired through a camera.

The color masking image may be an image encoded by masking a specific object within a region of interest of a produced content through a Gaussian filter and then removing noise from the masked specific object.

The video masking image may be an image of a red, green, blue, alpha (RGBA) channel of a specific object in a region of interest of a produced content.

The color masking image may be an image with less data than the data of the video masking image.

The synchronization unit may be configured to synchronize the video masking image to the color masking image with less data than the data of the video masking image.

The pixel image may be a specific object within a region of interest of a produced content.

Another aspect is an AR image receiving method that includes: receiving content, and by using session information of each of a color masking image and a video masking image for an object in a region of interest within the received content, demultiplexing the color masking image and the video masking image, respectively; synchronizing the video masking image and the color masking image by using timestamps of the demultiplexed color masking image and video masking image; decoding the synchronized video masking image and color masking image, respectively; and transforming the decoded video masking image and color masking image at the pixel level, respectively, and then extracting pixel images in a region where the transformed video masking image and color masking image match, and then binding the extracted pixel images and pixel-level camera images acquired through a camera.

According to an exemplary embodiment, decoding rendering is carried out with a color masking image, and a video masking image of a specific object, which have been received in real-time via a communication network, and then binding is carried out with a camera image, and thus the boundary of the specific object can be clearly distinguished, thereby enabling the enhancement of resolution and immersion.

### BRIEF DESCRIPTION OF THE DRAWINGS

The following drawings attached in the present specification illustrate preferred embodiments of the present disclosure and serve to further understand the technical idea of the present disclosure along with detailed descriptions of the present disclosure described later, and thus the present disclosure should not be construed as being limited to the matters described in such drawings.

FIG. 1 is a block diagram of an AR image receiving device according to an exemplary embodiment.

FIG. 2 is an exemplary view illustrating an output image of each unit of FIG. 1.

FIG. 3 is an entire flowchart illustrating an AR image receiving process according to another exemplary embodiment.

### DETAILED DESCRIPTION

The AR system provides the moved bounding box by identifying the movement of the object in successive frames when the bounding box of a specific object is given for each frame, regardless of the object category (class-agnostic).

However, these AR systems reproduce the final image by bounding the masking image of a specific object in the input image and the camera input image.

In this case, if a rendering error occurs at the boundary of the masking image, the resolution deteriorates rapidly and reaches a limit where immersion is reduced.

Accordingly, the applicant proposes a method to improve resolution and immersion by synchronizing a color masking image of a specific object and a video masking image of the specific object in a receiving device and then binding them with a camera image, thereby clearly distinguishing the boundary of the specific object.

Hereinafter, embodiments of the present disclosure will be described in more detail with reference to the accompanying drawings.

Advantages and features of the present disclosure, and a method of achieving them will be apparent with reference to the embodiments described below together with the accompanying drawings. However, the present disclosure is not limited to the embodiments disclosed below, and may be embodied in various forms. Rather, the description of the embodiments of the present disclosure is provided so that this disclosure will be thorough and complete and will fully convey the concept of the invention to those of ordinary skill in the art. Accordingly, the present disclosure is only defined by the scope of the appended claims.

The terms used in the present specification will be briefly described, and the present disclosure will be described in detail.

The terms used in the present disclosure were selected from the most widely used general terms possible while considering the functions of the present disclosure, but these may vary depending on the intention of engineers working in the relevant technical field, precedents, or the emergence of new technologies. In addition, in certain cases, there are terms arbitrarily selected by the applicant, and in these cases, their meanings will be described in detail in the description section of the relevant invention. Therefore, the terms used in the present disclosure should be defined based on the meaning of the terms and the overall content of the present disclosure, rather than simply the names of the terms.

Throughout the specification, unless explicitly described to the contrary, the word “comprise or include” and variations such as “comprises or includes” or “comprising or including” will be understood to imply the inclusion of stated elements but not the exclusion of any other elements.

Therefore, the functions provided within components and “units” may be combined into a smaller number of components and “units” or further separated into additional components and “units”.

Hereinafter, exemplary embodiments of the present disclosure will be described in detail so that those of ordinary skill in the art can readily implement the present disclosure with reference to the accompanying drawings. And, to clearly describe the present disclosure in the drawings, parts not related to the description are omitted.

For each component to which an embodiment applies, any number of suitable components may be included. In general, computer and communication systems come in a wide variety of configurations, and the drawings do not limit the scope of the present disclosure to any particular configuration. Although the drawings illustrate one operating environment in which the various features disclosed in this patent document may be utilized, such features may also be utilized in any other suitable system.

In the description of the specification, the subject performing the operation may be a processor that synchronizes the received video masking image with a color masking image, decodes the synchronized color masking image and video masking image, respectively, and binds the pixel image and the camera image matching the decoded color masking image and the video masking image. As another example, it may be a recording medium in which a program that performs a synchronization and binding process between a color masking image and a video masking image is recorded or a graphic process unit (GPU) including the same.

Prior to describing this specification, a specific object refers to an object in a region of interest within the received content, and accordingly, a specific object and an object will be described in combination.

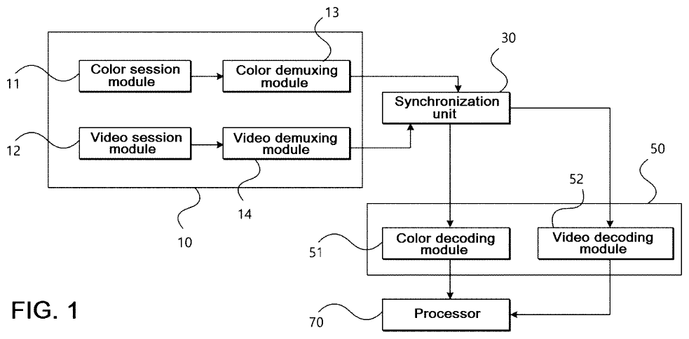

FIG. 1 is a diagram showing the configuration of an AR image receiving system according to an exemplary embodiment, and referring to FIG. 1, the AR image receiving device has a configuration that synchronizes the received video masking image to a color masking image, then decodes the synchronized color masking image and video masking image, respectively, extracts the pixel image that matches the decoded color masking image and video masking image, and then binds the extracted pixel image and camera image, and accordingly, the AR image receiving device S may include a receiving unit (or a receiver) 10, a synchronization unit (or a synchronizer) 30, a decoding unit (or a decoder) 50, and a processor 70.

Here, color masking image A is an image generated by extracting a partial image through a Gaussian filter for a specific object of the region of interest in the image of the produced content and then removing noise from the extracted partial image, video masking image B is a partial image of Red, Green, Blue, Alpha (RGBA) for a specific object of the region of interest in the image of the produced content, and camera image C is an input image acquired through at least one camera.

Color masking image A and video masking image B are transmitted to a receiving device S in the form of segments, and the quantity and quality of the segments can be adaptively streamed and transmitted according to the receiving environment through the HTTP (HyperText Transfer Protocol) transmission protocol in a broadband network, and UHD-level segments can be transmitted in real time through the ROUTE (Real-time Object delivery over Unidirectional Transport) protocol in a broadcast network.

In order for segments to be transmitted to a receiving device S to provide a UHD service, information on the type of service, transmission time, and transmission method should be transmitted to the receiving device. Signaling including a service layer signaling and a service list table including information about the transmission path of the service layer signaling may mean an object including information about the type of service, transmission time, and transmission method related to the segment to be transmitted.

Meanwhile, the receiving device S may transmit a transmission request including a partial image including a region of interest of the user. Accordingly, a necessary partial image may be transmitted in response to the information on the user's region of interest received from the transmission device (not shown). The receiving device S may bind the received necessary partial image to the input image of the camera.

In an embodiment, the receiving device S includes at least one processor and at least one memory configured to store instructions to be executed by the processor, and the instructions, when executed by the processor, allow the processor to perform an operation of acquiring information about a partial image of a user's region of interest, an operation of transmitting a request for transmitting a partial image to a transmission device (not shown), and an operation of binding corresponding to the information about the partial image and the input image of the camera.

Here, the receiving unit 10 may include a color session module 11 for a color masking image and a video session module 12 for a video masking image.

The color session module 11 and the video session module 12 detect session information of the color masking image and video masking image received in real-time, respectively, and provide the color masking image and the video masking image to demultiplexing modules (or demuxing modules) 13 and 14 of the receiving unit 10, respectively, using the detected session information.

The process of detecting session information of color masking images and video masking images received in real-time is not specifically specified in the present specification but may be understood at the level of those skilled in the art.

Here, the color demultiplexing module 13 and the video demultiplexing module 14 of the receiving unit 10 perform demultiplexing on each of the color masking image A and the video masking image B using the detected session information. Here, the process of performing demultiplexing by the demultiplexing modules 13 and 14 on the color masking image A and the video masking image B is not specifically specified in the present specification but may be understood at the level of those skilled in the art.

In addition, each of the demultiplexed color masking image and the demultiplexed video masking image is transmitted to the synchronization unit 30.

Accordingly, the synchronization unit 30 synchronizes the demultiplexed video masking image with the demultiplexed color masking image by using a timestamp extracted from the demultiplexed color masking image and the demultiplexed video masking image.

Here, since the color masking image received in real-time has a relatively less data than the data of the video masking image, the video masking image is synchronized to the color masking image.

In addition, each of the synchronized, demultiplexed video masking image and color masking image is transmitted to the decoding unit 50, the decoding unit 50 includes a color decoding module 51 and a video decoding module 52, and the color decoding module 51 decodes color masking images, and the video decoding module 52 decodes video masking images.

The process of decoding the video masking image and the color masking image synchronized by the timestamp by the decoding unit 50 is not specifically specified in the present specification but may be understood at the level of those skilled in the art.

Meanwhile, each of the video masking images and color masking images decoded by the decoding unit 50 is transmitted to the processor 70, and the processor 70 transforms the decoded video masking image and color masking image at the pixel level and then filters the remaining images except for the pixel images at which the decoded video masking image and color masking image match.

In addition, the processor 70 transforms the pixel image and the input image obtained from the camera at the pixel level and binds the pixel-level camera image and the pixel image to derive a final image.

Accordingly, in an embodiment, by synchronizing the received color masking image with the video masking image, performing decoding, and binding the decoded color masking image with the video masking image and the camera image, the boundary between the object of the region of interest and the background image is clearly distinguished, and thus high-resolution AR image reproduction is possible.

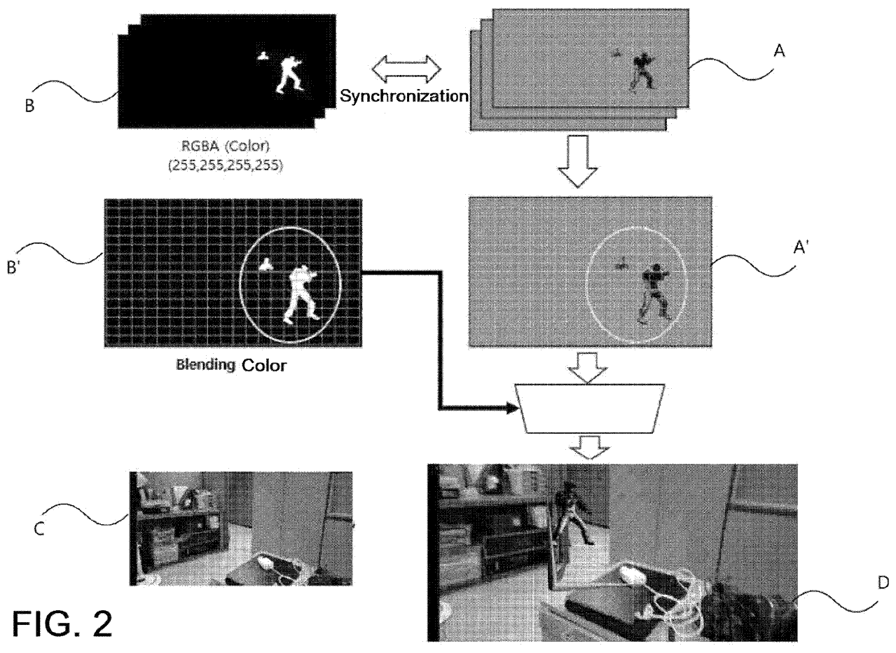

FIG. 2 is an exemplary view illustrating an output image of each unit of FIG. 1, and referring to FIG. 2, the video masking image B output from the receiving unit 10 and the color masking image A with a relatively smaller number of data than the video masking image B are synchronized by the synchronization unit 30, and the synchronized color masking image A and video masking image B are decoded by the decoding unit 50 to output the decoded color masking image A′ and video masking image B′ at the pixel level.

In addition, the processor 70 extracts a pixel image at a location where the pixel-level decoded color masking image A′ and video masking image B′ match, and then binds the extracted pixel image and the pixel-level transformed camera image C to derive a final image D.

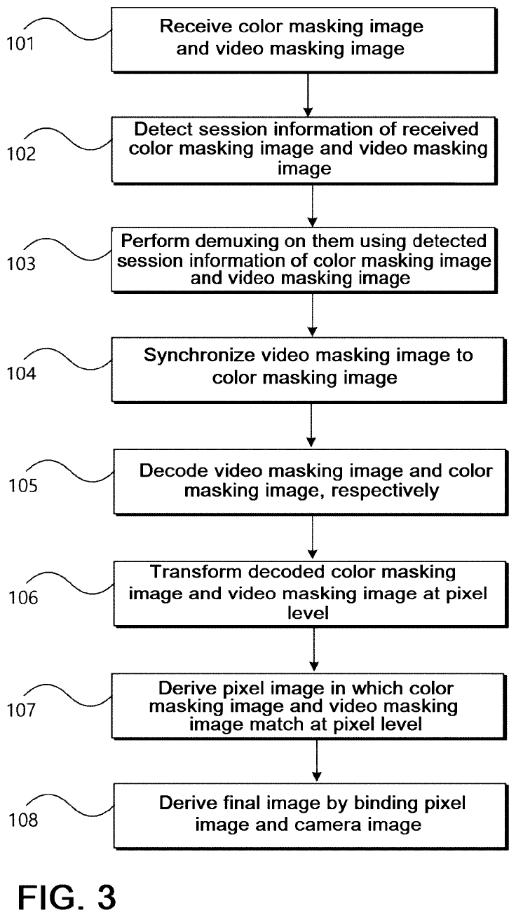

FIG. 3 is a diagram illustrating an operation process of the AR image receiving device of FIG. 1, and referring to FIG. 3, an AR image receiving process according to another embodiment will be described.

That is, based on steps 101 to 103, the receiving unit 10 according to an exemplary embodiment receives a color masking image and a video masking image in the form of a stream input in real-time and performs demultiplexing on them, respectively, using respective detected session information.

In step 104, the synchronization unit 30 according to an exemplary embodiment synchronizes the video masking image to the color masking image by using the timestamps of the color masking image and the video masking image extracted through demultiplexing.

Meanwhile, based on steps 104 and 105, the decoding unit 50 according to an exemplary embodiment decodes the synchronized video masking image and color masking image, respectively. In this case, since each of the decoding modules 51 and 52 performs decoding in parallel, the decoding time may be shortened.

Based on steps 106 and 107, the processor 70 according to an exemplary embodiment transforms each decoded video masking image and color masking image at the pixel level and removes the remaining regions except for the pixel regions at matching positions in the pixel-level video masking image and color masking image.

Meanwhile, based on step 108, the processor 70 according to an exemplary embodiment transforms the camera image into a pixel-level camera image, then binds the pixel images at matching positions in the transformed pixel-level camera image, the video masking image, and the color masking image to output a final image.

Accordingly, in an embodiment, by synchronizing the color masking image with the video masking image, performing decoding, and binding the decoded color masking image with the video masking image and the camera image, the boundary between the object of the region of interest and the background image is clearly distinguished, and thus high-resolution image reproduction is possible.

Although the embodiments have been described by limited examples and drawings, those skilled in the art will appreciate that various modifications and variations can be made from the above description. For example, suitable results may be achieved even if the described techniques are performed in a different order than described, and/or components of the described systems, structures, devices, circuits, etc. are coupled or combined in a different manner than described, or are replaced or substituted by other components or equivalents. Therefore, the scope of the present disclosure should not be limited to the described embodiments but should be defined not only by the claims described below but also by equivalents of the claims.

What is claimed is:

1. An augmented reality (AR) image receiving device, comprising:
a receiver configured to receive content, and by using session information of each of a color masking image and a video masking image for an object in a region of interest within the received content, to demultiplex the color masking image and the video masking image, respectively;
a synchronizer configured to synchronize the video masking image and the color masking image by using timestamps of the demultiplexed color masking image and video masking image;
a decoder configured to decode the synchronized video masking image and color masking image, respectively; and
a processor configured to transform the decoded video masking image and color masking image at the pixel level, respectively, and then extract pixel images in a region where the transformed video masking image and color masking image match, and then bind the extracted pixel images and pixel-level camera images acquired through a camera.

2. The AR image receiving device of claim 1, wherein the color masking image comprises an image encoded by masking a specific object within a region of interest of a produced content through a Gaussian filter and then removing noise from the masked specific object.

3. The AR image receiving device of claim 1, wherein the video masking image comprises an image of a red, green, blue, alpha (RGBA) channel of a specific object in a region of interest of a produced content.

4. The AR image receiving device of claim 1, wherein the color masking image comprises an image with less data than the data of the video masking image.

5. The AR image receiving device of claim 1, wherein the synchronizer is configured to synchronize the video masking image to the color masking image with less data than the data of the video masking image.

6. The AR image receiving device of claim 1, wherein the pixel image comprises a specific object within a region of interest of a produced content.

7. An augmented reality (AR) image receiving method performed by the AR image receiving device of claim 1, the method comprising:
receiving content, and by using session information of each of a color masking image and a video masking image for an object in a region of interest within the received content, demultiplexing the color masking image and the video masking image, respectively;
synchronizing the video masking image and the color masking image by using timestamps of the demultiplexed color masking image and video masking image;
decoding the synchronized video masking image and color masking image, respectively; and
transforming the decoded video masking image and color masking image at the pixel level, respectively, and then extracting pixel images in a region where the transformed video masking image and color masking image match, and then binding the extracted pixel images and pixel-level camera images acquired through a camera.

8. A computer readable recording medium storing instructions, when executed by one or more processors, causing the one or more processors to perform the method of claim 7.
